(19) United States
(12) Patent Application Publication
(10) Pub. No.: US 2007/0024896 A1
(43) Pub. Date: Feb. 1, 2007

(54) Printer mapping system

(75) Inventor: Dahmane Bounar, Dublin, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA SYSTEMS LABORATORY, INC.

(21) Appl. No.: 11/192,061

(22) Filed: Jul. 29, 2005

(51) Int. Cl. G06F 3/12

(52) U.S. Cl. 358/1.15

(57) ABSTRACT

The present application relates to a printing system in which a location of each printer can be displayed with a graphic map showing a layout of an office.

### FIELD

The present invention relates to a printing system.

By utilizing a printing system in which several printers and several personal computers (PC) are connected via a network, an user can print a document data according to an user's instruction from his/her PC in an office, a house or the like.

Such printing system is preferable because the user can select the printer easily depending on the user's purpose of the print (e.g., black and white or color prints, high speed or low speed and the like). However, the printing system typically exhibits certain drawbacks as the number of the printers increases in the office. For example, it may be difficult to find the printer which the user instructs to print in the office if the number of printers is high and the office space is large.

Therefore, it is desirable that the user can find easily the location of the printer which the user instructs to print in the office, the building or the like.

### SUMMARY

According to various embodiments, the present teachings can provide a printing system. The printing system can comprise a printer, a host computer and a client computer. The host computer can comprise a map data storing unit which stores a map data and a transmit unit which transmits the map data. The map data can comprise an office layout data showing a layout of an office graphically, and a printer location data showing a location of the printer graphically in the layout of the office. The client computer can comprise a display unit and an input unit by which an user can select the printer for printing. The printer, the host computer and the client computer can be connected via a network. The display unit can display the layout of the office and the location of the printer selected by the input section graphically based on the map data stored in the map data storing unit and transmitted by the transmit unit from the host computer to the client computer.

### BRIEF DESCRIPTION OF THE DRAWINGS

FIG. 1 illustrates a block diagram of a printing system according to certain embodiments.

FIG. 2 illustrates a graphic display of a print window according to certain embodiments.

FIG. 3 illustrates a graphic display of a main screen including an icon for displaying a map data according to certain embodiments.

FIG. 4 illustrates a graphic display of a graphic map data according to certain embodiments.

FIG. 5 illustrates a graphic display of an office layout data according to certain embodiments.

FIG. 6 illustrates a graphic display of a graphic map data composed of text data according to certain embodiments.

FIG. 7(a), (b), (c) and (d) illustrates a flowchart describing the preparation and display of the map data, according to certain embodiments.

FIG. 8(a), (b), (c) and (d) illustrates a flowchart describing the preparation and display of the map data, according to other embodiments.

### DESCRIPTION OF CERTAIN EMBODIMENTS

<A> A Printing System

In certain embodiments, a printing system can comprise one or several printer(s), one or several host computer(s) and one or several client computer(s). In certain embodiments, the printing system can further comprise one or several management computer(s). In certain embodiments, the printing system can further comprise a network which connects the printer with the host computer, the client computer and/or the management computer.

Examples of the network consistent with certain embodiments of the invention include, but are not limited to, an internet, an intranet, a local area network (LAN) and a wide area network (WAN). The printer, the host computer, the client computer and/or the management computer can be connected with a wire or be connected with wireless by using radio frequency (RF) and/or infrared (IR) transmission.

In certain embodiments, an operating system software (OS), an application software and a printer driver software can be installed into the client computer, the host computer and/or the management computer. Examples of the application software consistent with certain embodiments of the invention include, but are not limited to, a word processor software (e.g., Microsoft Word™ etc.), an image processing software (e.g., Adobe Photoshop™ etc.), a spread sheet software (e.g., Microsoft Excel™ etc) and a viewer software (e.g., Acrobat Reader™ etc.). The application software can produce a document data. The document data can include document, drawing, table, picture and/or photo and the like. In certain embodiments, the printer driver software can control the printer connected with the client computer, the management computer and/or the host computer in which the printer driver software is installed. In certain embodiments, the printer driver software can produce a print job based on the document data. In certain embodiments, the printer driver software can control transmit of the print job from the client computer and/or the management computer to the host computer and/or the printer.

In certain embodiments, the printer driver software can be modified so that an icon for displaying the map data can be displayed in the client computer or the management computer. In certain embodiments, the printer driver software can be modified so than an icon for displaying the map data can be displayed in a print window (in other words, GUI (graphical user interface) of the printer driver) on the client computer or the management computer. In certain embodiments, the printer driver software can produce a polling request to ask the printer data to the printers. In certain embodiments, the printer driver software can be installed in each of the client computer(s). In certain embodiments, the printer driver software can be installed in the host computer and the printer driver software can be downloaded from the host computer to the client computer via the network.

In certain embodiments, an application software for producing a request signal for a map data and for displaying an icon for displaying the map data (in other words, the application software's own GUI) can be installed in each client computer(s). This application software can be independent application. And, an application software for replying to the request signal sent from the client computer can be installed in the host computer. In certain embodiments, an application software for producing the polling request to ask the printer data to the printers can be installed in the host computer.

1) A Client Computer

In certain embodiments, the client computer can produce the document data. The client computer can produce the print job based on the document data and send the print job to the printer. Normal users can use the client computer to produce the document data and/or to make printer print the document data. Example of the client computer consistent with certain embodiments of the invention include, but are not limited to, a PC and a personal digital assistance (PDA). The client computer can comprise a processing unit, a storing unit, a display unit, an input unit and a transmit unit.

In certain embodiments, the processing unit of the client computer can control the entire client computer and/or the various units in the client computer. The processing unit can run various software including the OS, the application software and the printer driver software. The processing unit can produce a document data to be printed using the application software. The processing unit can produce a print job based on the document data using the printer driver software. The processing unit can process and/or calculate several data. Example of the processing unit consistent with certain embodiments of the invention include, but are not limited to, a central processing unit (CPU) or a micro processing unit (MPU) with a memory and a software necessary for the processing.

In certain embodiments, the storing unit of the client computer can store several software including the OS, the application software and the printer driver software. In certain embodiments, the storing unit can store several data including the document data and the map data. Example of the storing unit consistent with certain embodiments of the invention include, but are not limited to, a hard disk, a memory (e.g., a random access memory (RAM) including NVRAM, M RAM, P RAM, Fe RAM, Flash RAM, and a read only memory (ROM)) and a removable data recording medium recorder/reader. Examples of a removable data recording medium for the removable data recording medium recorder/reader include, but are not limited to, a digital memory card, a compact disk (e.g., CD-R, CD-RW, etc.), and a digital versatile disk (e.g., DVD-R, DVD-RW, DVD+RW, etc.). Various types of digital memory cards compatible with certain embodiments of the invention include, but are not limited to, a secure digital (SD) memory card, Compact Flash™, Smart Media™, Memory Stick™, and the like.

In certain embodiments, the display unit of the client computer can display various images including the document data and the map data. Examples of the display unit consistent with certain embodiments of the invention include, but are not limited to, a liquid crystal display (LCD), a Braun tube, a cathode ray tube (CRT) and a plasma display panel.

In certain embodiments, the user can input various data (e.g. the map data), information, response or instruction (e.g., a selection of the printer for printing, an instruction to start printing, and an instruction to display the map data) to the client computer through the input unit of the client computer. Examples of the input section consistent with certain embodiments of the invention include, but are not limited to, a keyboard, a mouse, a push button, a touch panel and a removable data recording medium reader.

In certain embodiments, the transmit unit of the client computer can transmit various data (e.g., the print job) and various signal (e.g., a request signal of the map data, an instruction signal for start printing) from the client computer to the host computer, the management computer, the printer or other devices and can receive various data (e.g., the map data) and various signal from the host computer, the management computer, the printer or other devices. Examples of the transmit unit consistent with certain embodiments of the invention include, but are not limited to, a LAN adapter, a modem and a network card.

2) A Printer

The printer can make a print corresponding to the print job sent to the printer. Examples of the printer consistent with certain embodiments of the invention include, but are not limited to, a laser beam printer (LBP), a multi function laser beam printer including copy function (MFP), an ink jet printer (IJP), a thermal printer (e.g., a dye sublimation printer) and a silver halide printer. The printer can be a color printer or a black and white (B/W) printer. In certain embodiments, the printer can comprise a processing unit, a print unit and a transmit unit. In certain embodiments, the printer can further comprise a storing unit, a display unit and/or a detecting unit.

In certain embodiments, the processing unit of the printer can control the entire printer and/or the various units in the printer. The processing unit can process the print job. The processing unit can decode and/or decompress the print job. The processing unit can rasterize the print job to produce the print data by which the print unit can print. The processing unit can process and/or calculate several data. Example of the processing unit consistent with certain embodiments of the invention include, but are not limited to, a CPU or a MPU (with a memory and a software for processing, if necessary) and an integrated circuit (IC), an application specific integrated circuit (ASIC), a field programmable gate array (FPGA) and a programmable logic device (PLD).

In certain embodiments, the print unit of the printer can print on a recording sheet according to the print job. For instance, the recording sheet can be a paper, OHP film and so on. Examples of the print unit consistent with certain embodiments of the invention include, but are not limited to, an image forming unit or a print engine for the laser beam MFP or the LBP, an ink jet head of the IJP and a thermal head of the thermal printer. In certain embodiments, the print engine or the image forming unit can comprise a laser beam scanning unit, a photo-sensitive drum (in other words, a photoconductor), a cleaning unit, an eraser lamp, a charging charger, a developing device, a transmit charger and so on. In certain embodiments, the image forming unit or the print engine for the color LBP, the color laser beam MFP can comprise one laser beam scanning unit and several imaging units corresponding to each color of C (cyan), M (magenta), Y (yellow) and K (black) and comprising the photo-sensitive drum, the cleaning unit, the eraser lamp, the charging charger, the developing device, the transmit charger and so on.

In certain embodiments, the transmit unit of the printer can transmit various data (e.g., the printer data) and various signal from the printer to the client computer, the host computer, the management computer or other devices and can receive various data (e.g., the print job, the document data) and various signal (e.g., the polling request for the printer data, the instruction to start to print) from the client computer, the host computer, the management computer or other devices. Examples of the transmit unit consistent with certain embodiments of the invention include, but are not limited to, a LAN adapter, a modem and a network card.

In certain embodiments, the storing unit can store the printer data including at least one of the category of the printer (e.g., color printer or B/W printer, or the LBP, the laser beam MFP, the IJP, the thermal printer or the silver halide printer), the manufacturer of the printer, the name of the printer, the spec data of the printer (e.g., the speed of the printer, the resolution of the printer, whether the printer can conduct duplex print and simplex print or only simplex print, whether the MFP has an auto document feeder or not). Example of the storing unit consistent with certain embodiments of the invention include, but are not limited to, a hard disk and a memory (e.g., a RAM including NVRAM, M RAM, P RAM, Fe RAM, Flash RAM, and a ROM).

In certain embodiments, the display unit of the printer can display various condition, information or instruction. Examples of the display unit consistent with certain embodiments of the invention include, but are not limited to, a LCD.

In certain embodiments, the detecting unit of the printer can detect the printer data such as the condition of the printer (e.g., the amount of consumable (e.g., paper, toner, ink and the like) in the printer, the information about whether the printer is jammed or not, the information about whether the print job is remained in the printer or not, the information about whether the printer is out of service or not). Example of the detecting unit consistent with certain embodiments of the invention include, but are not limited to, the CPU or the MPU (with a memory and a software for detecting, if necessary), various physical sensor (e.g., a touch sensor, a pressure sensor, an optical sensor, a temperature sensor and a humidity sensor).

3) A Host Computer

In certain embodiments, the host computer can manage the entire printing system. In certain embodiments, the host computer can control data flow in the printing system. The host computer can store the map data and give the map data to the client computer and/or the management computer. Example of the host computer consistent with certain embodiments of the invention include, but are not limited to, a server computer and a PC. The host computer can comprise a map data storing unit. The host computer can further comprise a processing unit and a transmit unit.

In certain embodiments, the map data storing unit of the host computer can store the map data. In certain embodiments, the map data storing unit can store the up-to-date map data. The map data storing unit can store other data (e.g., the correct password and/or ID) and/or various software (including the OS, the application software and the printer driver software). Example of the map data storing unit consistent with certain embodiments of the invention include, but are not limited to, a hard disk, a memory (e.g., a RAM including NVRAM, M RAM, P RAM, Fe RAM, Flash RAM) and a removable data recording medium recorder/reader. The removable data recording medium is described in the above.

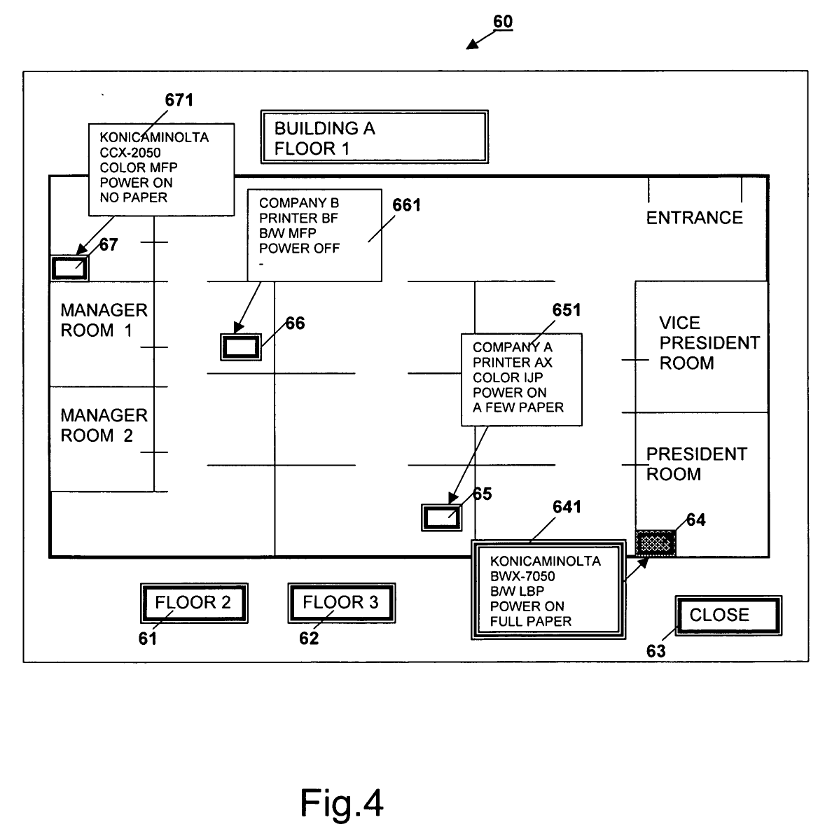

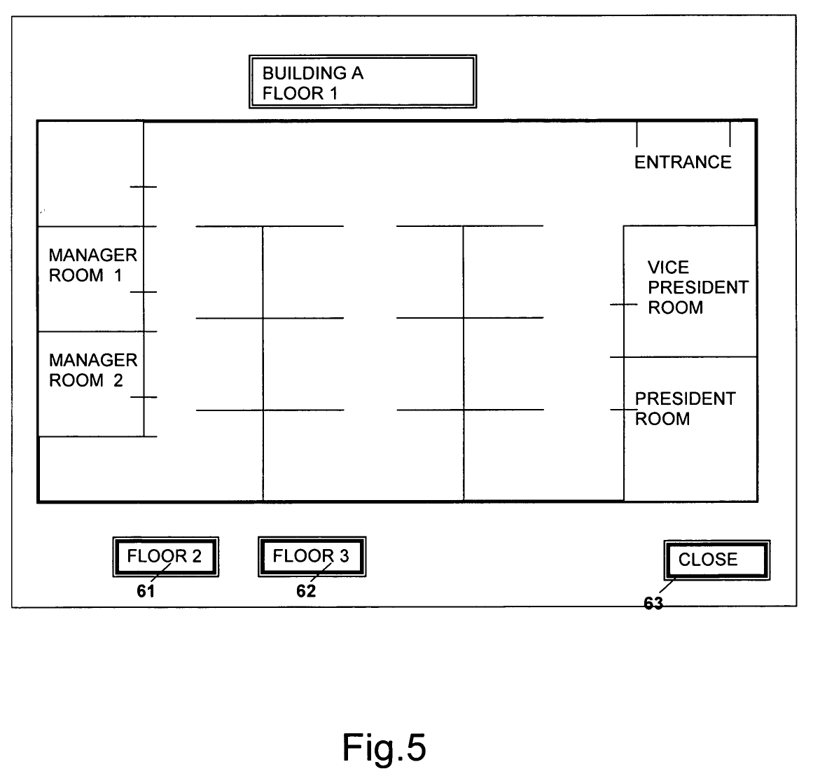

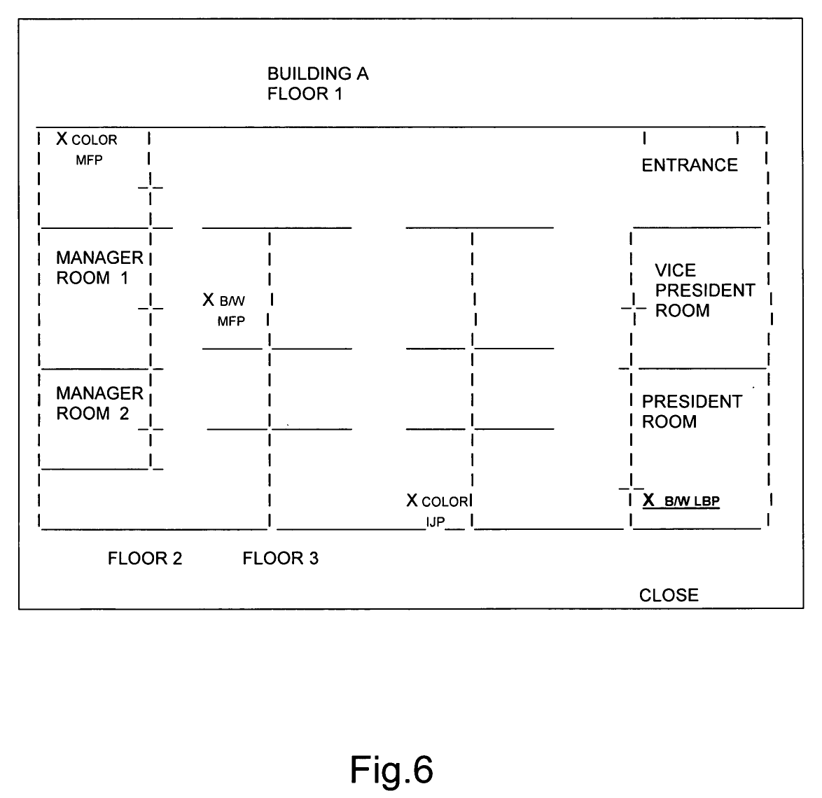

As illustrated in FIG. 4, the map data can be a data for graphically showing the layout of the office, the room, the floor, the building or the house (hereinafter collectively referred to as “the office”) and the location of the printer in the office. Although it is preferable that the map data is a graphic data, the map data can be a diagram data consisted of the text data, as illustrated in FIG. 6. The map data can comprise an office layout data and a printer location data. The office layout data can be a data showing a graphic layout of the office, as illustrated in FIG. 5. The printer location data can be a data showing where the printer is located in the office layout data. In certain embodiments, the map data can further comprise the printer data. The printer data can comprise at least one of the category of the printer (e.g., color printer or B/W printer, or the LBP, the laser beam MFP, the IJP, the thermal printer or the silver halide printer), the manufacturer of the printer, the name of the printer, the spec data of the printer (e.g., the speed of the printer, the resolution of the printer, whether the printer can conduct duplex print and simplex print or only simplex print, whether the MFP has an auto document feeder or not), the condition of the printer (e.g., the amount of the consumable such as paper, ink, toner in the printer, the information about whether the printer is turned on or off, the information about the printer is jammed or not, the information about whether the print job is remained in the printer or not, the information about whether the printer is out of service or not). In certain embodiments, the map data can comprise a computer location data. The computer location data can be the data showing where the client computer, the management computer or the host computer is located. The computer location data can comprise an ID data (e.g., IP address, MAC address and the like) of each client, management or host computer for identifying the client computer, the management computer or the host computer. The data describing the location of the printer only in words (e.g., a manager room on the 1^{st} floor, or the next to the entrance and the like) without a graphic is not the map data for this invention.

In certain embodiments, the processing unit of the host computer can control the entire host computer and/or the various units in the host computer. The processing unit can run various software including the OS, the application software and the printer driver software. The processing unit can process and/or calculate several data. In certain embodiments, the processing unit can produce a polling request for requesting the printer data to the printer. In certain embodiments, the processing section can judge whether the password and/or ID input in the management computer is correct password and/or ID. Example of the processing unit consistent with certain embodiments of the invention include, but are not limited to, a CPU or a MPU with a memory and a software necessary for the processing.

In certain embodiments, the transmit unit of the host computer can transmit various data (e.g., the map data, the document data, the print job) and various signal (e.g., a polling request for the printer data, an instruction signal for start printing) from the host computer to the client computer, the management computer, the printer or other devices and can receive various data (e.g., the map data, the printer data, the document data, the print job) and various signal (e.g., a request signal for the map data) from the client computer, the management computer, the printer or other devices. Examples of the transmit unit consistent with certain embodiments of the invention include, but are not limited to, a LAN adapter, a modem and a network card.

4) A Management Computer

In certain embodiments, the management computer can input or change the map data into the printing system. In certain embodiments, only authorized person (e.g., IT (information technology) management person) can use the management computer and can input or change the map data from the management computer. Example of the management computer consistent with certain embodiments of the invention include, but are not limited to, a PC. The management computer can comprise a processing unit, a storing unit, a display unit, an input unit and a transmit unit.

In certain embodiments, the processing unit of the management computer can control the entire management computer and/or the various units in the management computer. The processing unit can run various software including the OS, the application software and the printer driver software. The processing unit can process and/or calculate several data. The processing unit can authorize only specific person to operate the management computer. In certain embodiments, the processing unit can authorize the user to use the management computer by judging whether the password and/or ID input in the management computer by the user is correct password and/or ID or not. In certain embodiments, the processing unit can judge the input password and/or ID is correct when the input password and/or ID is identical with the password and/or ID stored in the storing unit. Example of the processing unit consistent with certain embodiments of the invention include, but are not limited to, a CPU or a MPU with a memory and a software necessary for the processing and authorizing.

In certain embodiments, the storing unit of the management computer can store various software including the OS, the application software and the printer driver software. In certain embodiments, the storing unit can store several data (e.g., the correct password, the correct ID, the document data and the map data). Example of the storing unit consistent with certain embodiments of the invention include, but are not limited to, a hard disk, a memory (e.g., a RAM including NVRAM, M RAM, P RAM, Fe RAM, Flash RAM, and a ROM) and a removable data recording medium recorder/reader. The removable data recording medium is described in the above.

In certain embodiments, the display unit of the management computer can display various images including the document data and the map data. Examples of the display unit consistent with certain embodiments of the invention include, but are not limited to, a LCD, a Braun tube, a CRT and a plasma display panel.

In certain embodiments, the authorized person can input various data (e.g., the map data), information (e.g., correct password, correct ID), response or instruction (e.g., an instruction to start printing, and an instruction to display the map data) to the management computer through the input unit of the management computer. Examples of the input section consistent with certain embodiments of the invention include, but are not limited to, a keyboard, a mouse, a push button, a touch panel and a removable data recording medium reader.

In certain embodiments, the transmit unit of the management computer can transmit various data (e.g., the map data) and various signal (e.g., a request signal of the map data, an instruction signal for start printing) from the management computer to the host computer, the client computer, the printer or other devices and can receive various data (e.g., the map data) and various signal from the host computer, the client computer, the printer or other devices. Examples of the transmit unit consistent with certain embodiments of the invention include, but are not limited to, a LAN adapter, a modem and a network card.

<B> A Procedure for Mapping the Printer

1) Preparation of the Map Data

1-1) Management Computer'S Authorization

If the printing system does not comprise the management computer, the description in this 1-1) can be omitted.

In certain embodiments, the management computer is turned on. Then, the management computer can request to input the password and/or ID of the user by showing the request message on the display unit.

If the password and/or ID is input to the management computer, the management computer can judge whether the input password and/or ID is correct or not. If the management computer judges the input password and/or ID is correct, the management computer can allow the user to use and access the management computer. On the other hand, if the management computer judges the input password and/or ID is not correct, the management computer can prohibit the user from using and accessing the management computer. In certain embodiments, the management computer can judge whether the input password and/or ID is correct or not, by comparing the input password and/or ID with the correct password and/or ID stored in the management computer. If the input password and/or ID is identical with the stored password and/or ID, the input password and/or ID can be deemed as correct.

In certain embodiments, instead of the management computer, the host computer can judge whether the input password and ID is correct or not. In this case, the input password and ID can be transmitted from the management computer to the host computer through the network and the host computer can store the correct password and ID.

1-2) Preparation of the Map Data

In certain embodiments, drawing a graphic of the office layout and/or the printer utilizing some application software for drawing the graphic, a manufacturer of the printer, the user or the IT management person can design and create the office layout data and the printer location data. In certain embodiments, a part of the office layout data can be produced by extracting some data about a location of the printer included in the printer driver software, the OS or the application software.

In certain embodiments, the office layout data and the printer location data representing the map data can be input from the management computer. Also, the printer data such as the category of the printer, the manufacturer of the printer, the name of the printer or the spec data of the printer, except the condition of the printer can be input as the map data from the management computer.

The map data input from the management computer can be transmitted from the management computer to the host computer via the network. Then, the host computer can store the map data. In certain embodiments, the map data can be also stored in the management computer. In certain embodiments, the computer location data can be input from the management computer.

When the layout of the office is changed, the up-to-date office layout data can be input from the management computer. When the location of the printer, the client computer or the management computer in the office is changed, a new printer, a new client computer or a new management computer is introduced into the printing system, the up-to-date printer location data or the up-to-date computer location data can be input from the management computer.

In certain embodiments, if the printing system does not comprise the management computer, the map data can be input from the client computer and can be sent from the client computer to the host computer instead of the management computer,

In certain embodiments, the printer data can be sent from the printer to the host computer if the map data comprises the printer data, especially the data of the condition or status of the printer. In certain embodiments, the printer data stored in the printer can be sent from the printer to the host computer. In certain embodiments, the printer data detected by the printer can be sent from the printer to the host computer.

In certain embodiments, the printer can voluntarily detect and/or send the printer data to the host computer. The printer can voluntarily detect and/or send the printer data to the host computer periodically (e.g. every 30 minutes, 1 hour, 5 hours, 1 day, 1 week, 1 month and the like). In certain embodiments, the client computer, the management computer or the host computer can send a polling request for requesting the printer data to the printer and the printer receiving the polling request can detect and/or send the printer data to the client computer, the host computer and the management computer sending the polling request. In certain embodiments, the polling request can be sent to the printer automatically and periodically (e.g. every 30 minutes, 1 hour, 5 hours, 1 day, 1 week, 1 month and the like). In certain embodiments, the polling request can be sent from the host computer, the client computer or the management computer to the printer every time after the user instructs start of printing or requests the map data from the client computer or the management computer. In certain embodiments, the client computer, the management computer or the host computer can judge that the printer is turned off or disconnected, if the client computer, the management computer or the host computer cannot receive any reply from the printer even though the client computer, the management computer or the host computer sends a polling request for requesting the printer data to the printer.

1-3) Installation of the Software

In certain embodiments, the printer driver software can be modified so that an icon for displaying the map data can be displayed in the print window or the other window on the client computer or the management computer. The printer driver software can be recorded on the removable data recording medium or the printer driver software can be distributed via the network. The removable data recording medium is described in the above. In certain embodiments, the printer driver software can be installed in the client computer, the host computer and/or the management computer. In certain embodiments, the printer driver software can be installed in each of the client computer(s). In certain embodiments, the printer driver software can be installed in the host computer and the printer driver software can be downloaded from the host computer to the client computer via the network.

In certain embodiments, the application software for producing the request signal to request the map data and for displaying the icon to request the map data can be installed in each client computer(s). And, the application software for replying to the request signal to request the map data sent from the client computer can be installed in the host computer. If the above application software is installed in the printing system, it is not necessary to modify the printer driver software and the OS.

2) Display of the Map Data

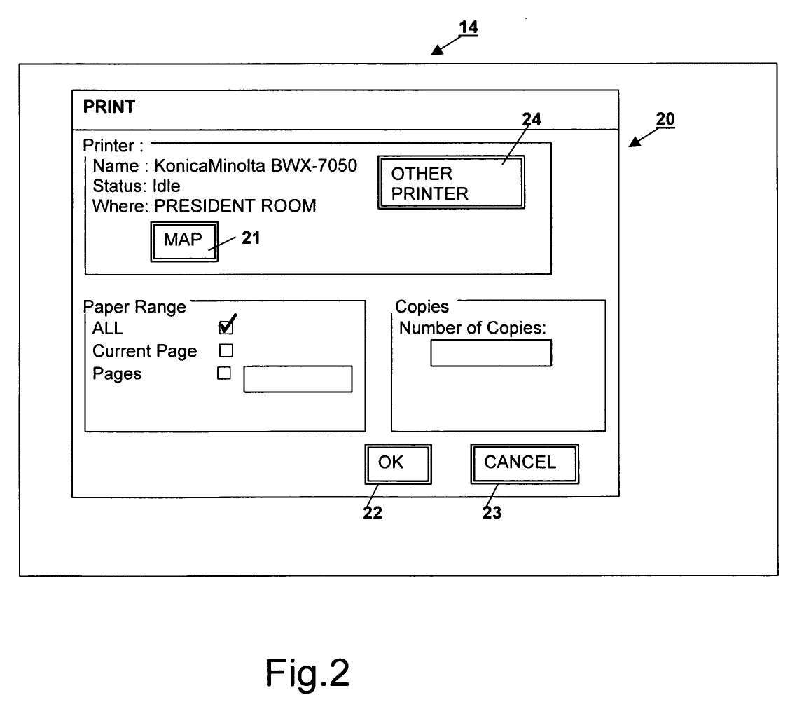

In certain embodiments, a print window can be displayed on the client computer when the user instructs start of printing the document data from the client computer during the running of the application software. By user's input of information or instruction to the print window, the user can select the printer, change print condition and the like. One of the examples of the print window is illustrated in FIG. 2. In certain embodiments, an icon 21 for requesting to display the map data can be embedded in the print window. In this case, to display the icon in the print window, the printer driver software can be modified.

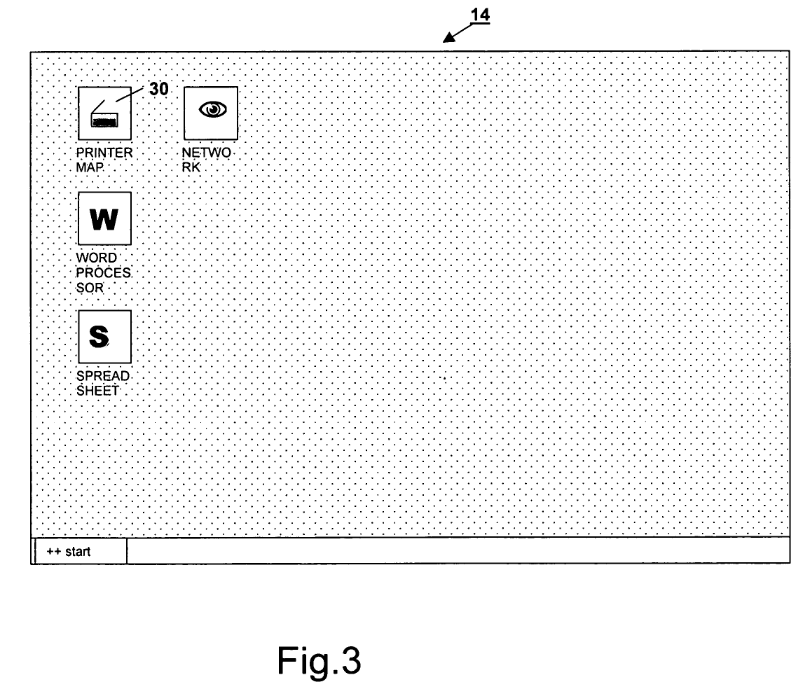

In certain embodiments, the icon for requesting to display the map data can be displayed on the client computer in a screen other than the print window. As illustrated in FIG. 3, the icon 30 for requesting to display the map data can be displayed on a main screen of the client computer. In this case, the application software for displaying the icon can be installed independently of the OS and the printer driver software. So, it's not necessary to modify the OS and the printer driver software to display the icon for requesting to display the map data.

If the user requests to display the map data from the client computer (e.g., by clicking the icon for requesting to display the map data on the client computer), a request signal for displaying the map data can be transmitted from the client computer to the host computer through the network. In certain embodiments, the ID data for the client computer can be transmitted with the request signal. After the host computer receives the request signal, the host computer can transmit the map data stored in the host computer to the client computer sending the request signal. Then, the client computer receiving the map data can display a map window for showing the map data.

In certain embodiments, after the host computer receives the request signal, the host computer can transmit the polling request to the printer to collect the printer data. Then, the host computer can receive the printer data from the printer, produce the map data including the printer data sent from the printers and then transmit the map data to the client computer sending the request signal.

In certain embodiments, after the host computer receives ID data for the client computer, the host computer can specify the location of the client computer by comparing the ID data stored in the host computer as a part of the computer location data with the ID data transmitted from the client computer. Then, the map data can show where the client computer sending the request signal is located in the office layout. The client computer can display the map window showing the location of the client computer.

One of the examples of the map window is illustrated in FIG. 4. In the map window 60, the map data can be displayed. In the map window 60, the layout of the office and the location of the printers can be displayed graphically. In certain embodiments, the location of the printers can be displayed by printer icons 64, 65, 66, 67 displayed in the office layout data. In certain embodiments, if the map data comprises the printer data (e.g., the category of the printer, the name of the printer, the spec of the printer the condition of the printer and the like), the printer data 641, 651, 661, 671 can be also displayed in the map window. In certain embodiments, the selected printer can be displayed in the map window emphatically (e.g., different graphic, different color, different font, highlight, a bold line, a blink or the like). In certain embodiments, an icon 61, 62 for changing area (e.g., a building, a floor, a room and the like) of the map data can be displayed in the map window. An icon 63 for closing the map window can be displayed in the map window.

In certain embodiments, the user can select or change the printer to print by clicking the printer icon, which is corresponding to the printer by which the user wants to print, in the map window. In certain embodiments, the user can change the area (e.g., a building, a floor, a room and the like) of the map data by clicking the icon for changing area in the map window. If the user clicks the icon for closing the map window, the map window can close. In certain embodiments, after closing the map window, the print window can be displayed. In certain embodiments, if the user selects or changes the printer by clicking the printer icon in the map window, that selection or change can be reflected on the selected printer in the printer window.

In certain embodiments, once the map data is transmitted to the client computer, the client computer can store a part of the map data (e.g., only the office layout data, or the map data except the printer condition data or the like) Then, when the client computer requests the map data next time, only the map data which is not stored in the client computer can be transmitted from the host computer. In certain embodiments, the map data can included the up-to-date data showing when the map data is changed. Based on the up-to data, the client computer can judge whether stored map data can be used or not. In certain embodiments, if the user wants to use the management computer as the client computer, the icon for requesting to display the map data, the print window and/or the map window can be displayed on the management computer instead of the client computer.

3) Print

After the user designates the printer to print as the user looks at the map window, the user can instruct start of printing from the client computer (e.g., by clicking an icon for starting the print in the print window, by double clicking the printer icon in the map window, or by clicking the pull down menu on the menu bar or the like). Then, the client computer can produce the print job based on the document data and transmit the print job to the designated printer directly or through the host computer. The printer can print based on the print job sent from the client computer.

In certain embodiments, if the user wants to use the management computer as the client computer, the user can instruct start of printing from the management computer instead of the client computer.

### EXAMPLE 1

One example of the printing system is described in the following. This invention is not limited to the following example.

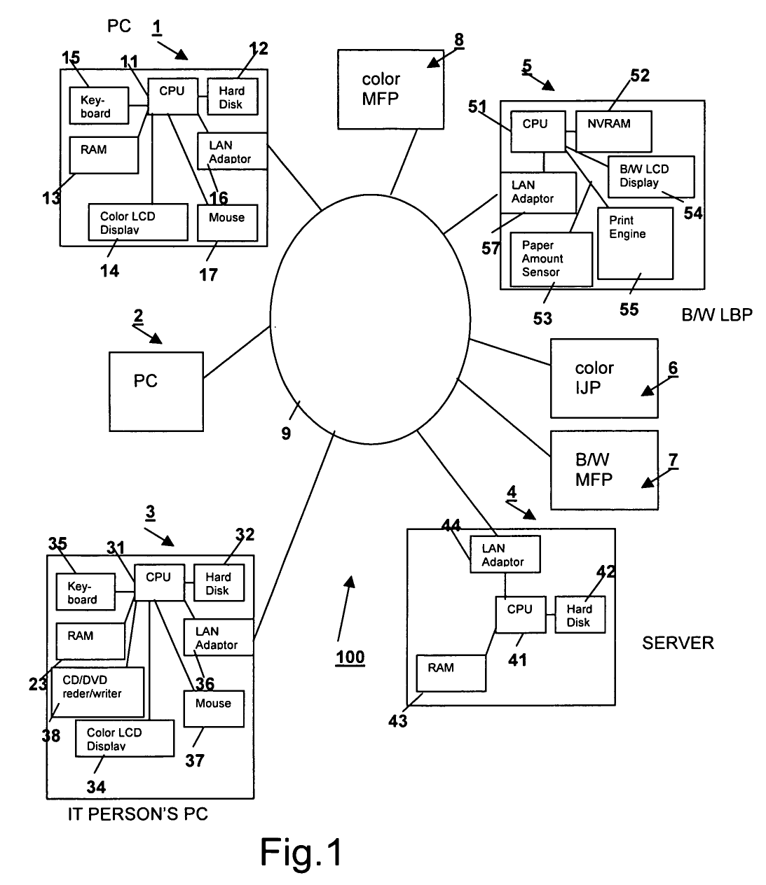

In certain embodiments, as illustrated in FIG. 1, the printing system (e.g., a printing system 100) can comprise two clients computer (e.g., a PC 1, a PC 2), a management computer (e.g., an IT person's PC 3), a host computer (e.g., a server 4), four printers (e.g., a BNV LBP 5, a color IJP 6, a BAN MFP 7, a color MFP 8) and a network (e.g., LAN 9) connecting the PC 1, PC 2, the IT person's PC 3, the B/W LBP 5, the color IJP 6, the B/W MFP 7 and the color MFP 8.

As illustrated in FIG. 1, the PC 1 can comprise a processing unit (e.g., a CPU 11 and a RAM 13 with necessary software for processing), an input unit (e.g., a mouse 17 and a keyboard 15), a storing unit (e.g., the RAM 13 and a hard disk 12), a display unit (e.g., a color LCD display 14) and a transmit unit (e.g., a LAN adaptor 16).

The IT person's PC 3 can comprise a processing unit (e.g., a CPU 31 and a RAM 33 with necessary software for processing and authorizing), an input unit (e.g., a CD/DVD reader/writer 38, a mouse 37 and a keyboard 35), a storing unit (e.g., the RAM 33 and a hard disk 32), a display unit (e.g., a color LCD display 34) and a transmit unit (e.g., a LAN adaptor 36).

The server 4 can comprise a processing unit (e.g., a CPU 41 and a RAM 43 with necessary software for processing), a map data storing unit (e.g., the RAM 43 and a hard disk 42) and a transmit unit (e.g., a LAN adaptor 46).

The B/W LBP 5 can comprise a print unit (e.g., a print engine 55), a processing unit (e.g., a CPU 51 and a NVRAM 52 with necessary software for processing), a storing unit (e.g., the NVRAM 52), a detecting unit (e.g., a paper amount sensor 53), a display unit (e.g., a BAN LCD display 54) and a transmit unit (e.g., a LAN adaptor 57). The OS and the application software (e.g., Microsoft Word, Adobe Photoshop and the like) recorded on a CD-ROM can be installed in the PC 1, the PC2, the IT person's PC 3 and the server 4. The printer driver software for the B/N LBP 5, the color IJP 6, the B/W MFP 7 and the color MFP 8 recorded on a CD-ROM can be installed in the PC 1, 2 and IT person's PC 3. The printer driver software can include program for producing the print job based on the document data. An application software for producing a request signal for requesting to display the map data and for displaying an icon for requesting to display the map data ca be installed in each of the PC 1, PC 2 and IT person's PC 3. And, an application software for replying to the request signal sent from the client computer can be installed in the server 4. In this example, the OS and the printer driver software are not necessary to be modified so that the icon for requesting to display the map data can be displayed.

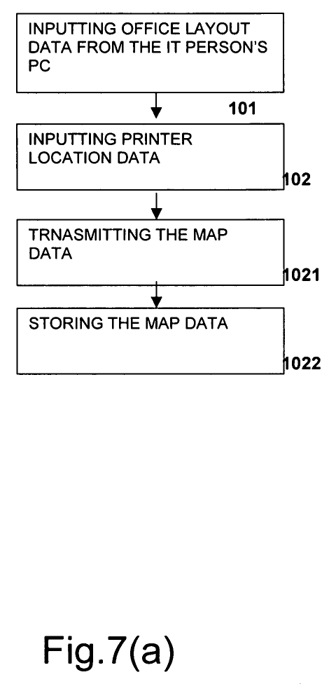

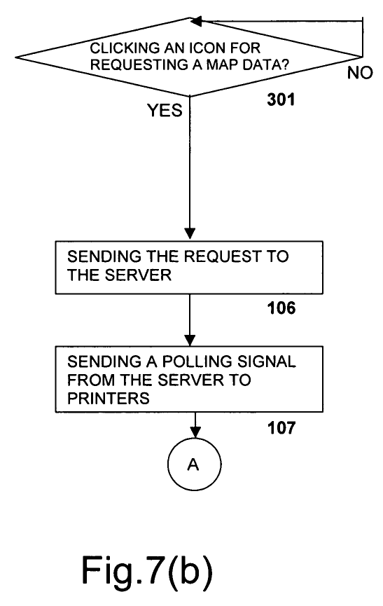

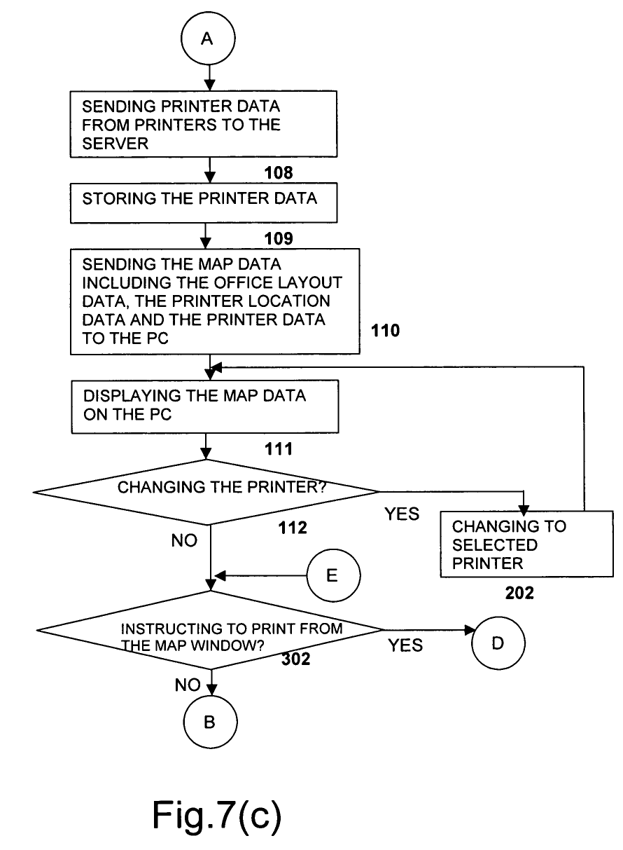

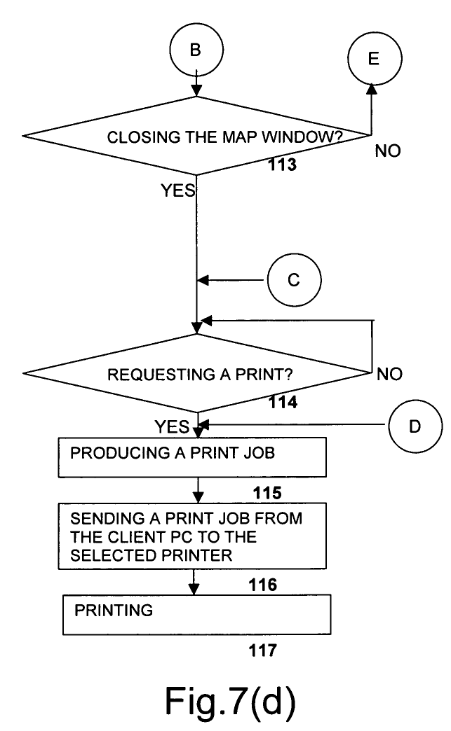

The following describes how to prepare and display the map data as illustrated in FIGS. 7 (a), (b) and (c).

The user (e.g., IT management person) who inputs the map data into the printing system needs to be authorized to use the IT person's PC 3. First of all, the IT person's PC 3 is turned on. Then, the CPU 31 of the IT person's PC can request to input the password and ID of the user by showing the request message on the color LCD display 34. A correct password and ID can be stored in the hard disk 32 beforehand.

If the user inputs the password and ID with the keyboard 35 and the mouse 37 to the IT person's computer 3, the CPU 31 can judge whether the input password and ID is correct or not by comparing the input password and ID with the correct password and ID stored in the hard disk 32.

If the CPU 31 judges the input password and ID is identical with the password and ID stored in the hard disk 32 and the input password and ID are correct, the CPU 31 can authorize the user to use and access the IT person's PC 3. On the other hand, if the CPU 31 judges the input password and ID is different from the password and ID stored in the hard disk 32 and the input password and ID are not correct, the CPU 31 can prohibit the user from using and accessing the IT person's PC 3.

After the IT management person is authorized to use the IT person's PC 3, he or she can input the office layout data representing the map data to the IT person's PC 3 (101 in FIG. 7(a)). The office layout data can be produced at the IT person's PC 3 by drawing a graphic of the office layout utilizing the application software (e.g., Microsoft Word, CAD software and the like). Or, the office layout data can be input to the IT person's PC 3 by reading the office layout data recorded in the CD-ROM or DVD-ROM by the CD/DVD reader/writer 38. One example of the office layout data can be shown in FIG. 5.

After the office layout data is input to the IT person's PC 3, the printer location data representing the map data can be also input by designating the location of the printer on the office layout data using the keyboard 35 and/or the mouse 37 as displaying the office layout data on the color LCD display 34 (102 in FIG. 7(a)). In addition to the printer location data, a part of the printer data (e.g., the name of the manufacturer of the printer, the name of the printer and the category of the printer) representing the map data can be input by the keyboard 35, the mouse 37 and/or the CD/DVD reader/writer 38.

The map data including the office layout data, the printer location data and a part of the printer data input from the IT person's PC 3 can be stored in the hard disk 32 of the IT person's PC 3. Then, the input map data can be transmitted from the LAN adaptor 36 of the IT person's PC 3 to the server 4 through the LAN 9. (1021 in FIG. 7(a)) The server 4 can receive the map data via the LAN adaptor 44 of the server 4. The hard disk 42 of the server 4 can store the map data. (1022 in FIG. 7(a))

When the layout of the office is changed, the up-to-date office layout data can be input from the IT person's PC 3 as the above. When the location of the printer in the office is changed or a new printer is introduced into the printing system, the up-to-date printer location data and printer data can be input from the IT person's PC 3 as the above.

The user can produce the document data on the PC 1 utilizing the OS and the applications software. Or, the user can input the document data by reading the document data from the CD/DVD reader/writer (not shown) of the PC 1 or by downloading the document data via the LAN 9 to the PC 1.

As illustrated in FIG. 3, running the application software for displaying an icon for requesting to display the map data in the PC 1, the icon 30 can be displayed on a main screen displayed on the color LCD display 14 of the PC 1. When the user wants to display the map data, the user can click the icon 30 using the keyboard 15 and/or the mouse 17.

By clicking the icon 30, the user can request to display the map data (301 in FIG. 7(b)). If the icon 30 is clicked from the PC 1, a request signal for displaying the map data can be produced by the CPU 11 and be transmitted from the LAN adaptor 16 to the server 4 through the LAN 9 according to the application software for displaying the icon 30. (106 in FIG. 7(b))

After the sever 4 receives the request signal via the LAN adaptor 44, the CPU 41 of the server can produce a polling request for requesting the printer data to the printer and send the polling request from the LAN adaptor 44 to all of the printers (e.g., the B/W LBP 5, the color IJP 6, the B/W MFP 7 and the color MFP 8) connected to the LAN 9. (107 in FIG. 7(b))

If the printer connected to the LAN 9 is not turned on, the printer cannot reply to the polling request. Then, if the server 4 does not receive any reply from certain printer, the CPU 41 of the server 4 can regard the printer sending no reply as the printer which is turned off or disconnected.

If the printer connected to the LAN 9 is turned on, the printer can receive the polling request and send the printer data of the printer. For instance, after the B/W LBP 5 receives the polling request transmitted from the server 4 via the LAN adaptor 57, the paper amount sensor 53 can detect the amount of paper in the B/W LBP 5. The CPU 51 can produce the printer data of the printer condition (e.g., the paper amount) based on the detected result by the paper amount sensor 53. In certain embodiments, the printer data about the paper amount can be classified in 4 kinds of the data, that's are no paper (e.g., 0 sheet), a few paper (e.g., less than about 10 sheets), an enough paper (e.g., more than about 10 sheets and less than about 80 sheets), a full paper (e.g., more than about 80 sheets). Then, the BNV LBP 5 can transmit the printer data about the paper amount to the server 4 from the LAN adaptor 57. (108 in FIG. 7(c))

The server 4 can receive the printer data of the printer condition (e.g., the amount of the paper, and whether the printer is turned on or off) from all of the printers (e.g., the B/W LBP 5, the color IJP 6, the B/W MFP 7 and the color MFP 8) connected to the LAN 9 via the LAN adaptor 44. In other words, the server can collect the printer data of the printer condition through the LAN 9. In this example, the server 4 receives the following printer data from the printers.

B/W LBP 5: power ON, full paper

color IJP 6: power ON, a few paper

B/W MFP 7: power OFF (no reply from the printer)

color MFP 8: power ON, no paper

The CPU 41 can produce the complete map data by putting together the office layout data, the printer location data and a part of the printer data (e.g., the name of the manufacturer, the name of the printer, the category of the printer) stored in the hard disk 42 and the printer data about printer condition (e.g., the amount of the paper, and whether the printer is turned on or off) transmitted from the printers. Also, the complete map data can be stored in the hard disk 42. (109 in FIG. 7(c))

After producing the complete map data, the server 4 can transmit the map data, comprising the office layout data, the printer location data and the printer data of the printer condition, the name of the manufacturer, the name of the printer, the category of the printer, to the PC 1 which sends the request signal for displaying the map data from the LAN adaptor 44. (110 in FIG. 7(c))

Then, the PC 1 can receive the map data via the LAN adaptor 16. As illustrated in FIG. 4, the color LCD display 14 of the PC 1 can display a map window 60 showing the map data. (111 in FIG. 7(c)) The map data can be stored in the hard disk 12 and/or the RAM 13 of the PC 1.

As illustrated in FIG. 4, in the map window 60, the layout of the office and the location of the printers can be displayed graphically. The location of the printers can be displayed by printer icons 64, 65, 66 and 67. The printer data 641, 651, 661 and 671 for each printer can be also displayed in the map window. The icon 64 of the selected printer (in this example, the selected printer is the B/W LBP 5 as the default printer) can be displayed in different graphic for emphasis. The icon 61, 62 for displaying the map data of other floor can be included in the map window. By clicking the icon 61, 62, the user can see the map data of the other floor. An icon 63 for closing the map window can be displayed in the map window 60. By clicking the icon 63, the user can close the map window 60.

The user can change the printer to print by clicking the printer icon 64, 65, 66 and 67, which is corresponding to the printer by which the user wants to print, in the map window 60 with the keyboard 15 and the mouse 17 as the user sees the printer location in the map window. (112 in FIG. 7(c)) If the user changes the printer by clicking the printer icons 65, 66 or 67, the CPU 11 processes the print job and the map data stored in the RAM 13 and/or the hard disk 12 so that the change can be reflected on the map window 60 and the print job. (202 in FIG. 7 (c))

After the user decides the printer to print on the map window 60, the user can instruct to start to print by double clicking the printer icon 64, 65, 66 or 67. (302 in FIG. 7(c)) Or, the user can close the map window by clicking the icon 63. (113 in FIG. 7(d)) After closing the map window, the user can instruct to start to print by the designated printer from a printer window, other icon or the pull down menu.

Then, the CPU 11 of the PC 1 can produce the print job based on the document data and the PC 1 can transmit the print job to the designated printer (in this example, B/W LBP 5) from the LAN adaptor 16 through the server 4. The B/W LBP 5 can receive the print job through the server 4 and print based on the print job sent from the PC 1.

### EXAMPLE 2

Another example of the printing system is described in the following. This invention is not limited to the following example. Most of structure and procedure of this EXAMPLE 2 are similar to EXAMPLE 1. Only different points from EXAMPLE 1 are described as follows.

In this example, instead of installing the application software for displaying the icon for requesting to display the map data which is independent of the OS and the printer driver software, the printer driver software can be modified so that an icon for requesting to display the map data can be displayed in the print window.

With regard to request of the map data, it is described as follows.

When the user wants to print the document data, the user can open a print window displayed on the color LCD display 14 of the PC 1 by instructing the open of the print window from the keyboard 15 or the mouse 17 during the running of the application software (e.g., Microsoft Word and the like). The print window 20 displayed on the color LCD display 14 is shown in FIG. 2.

An icon 21 for requesting to display the map data, an icon 22 for starting print, an icon 23 for closing the print window and an icon 24 for changing the printer are included in the print window 20.

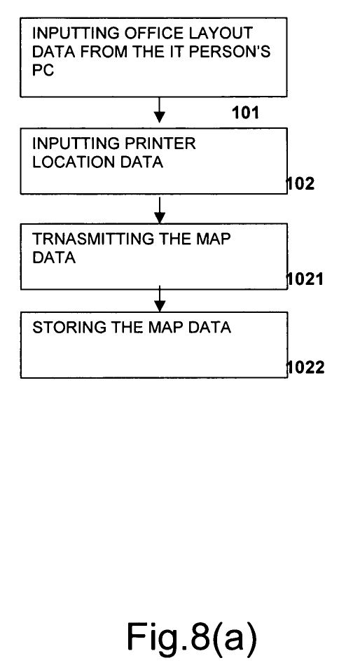

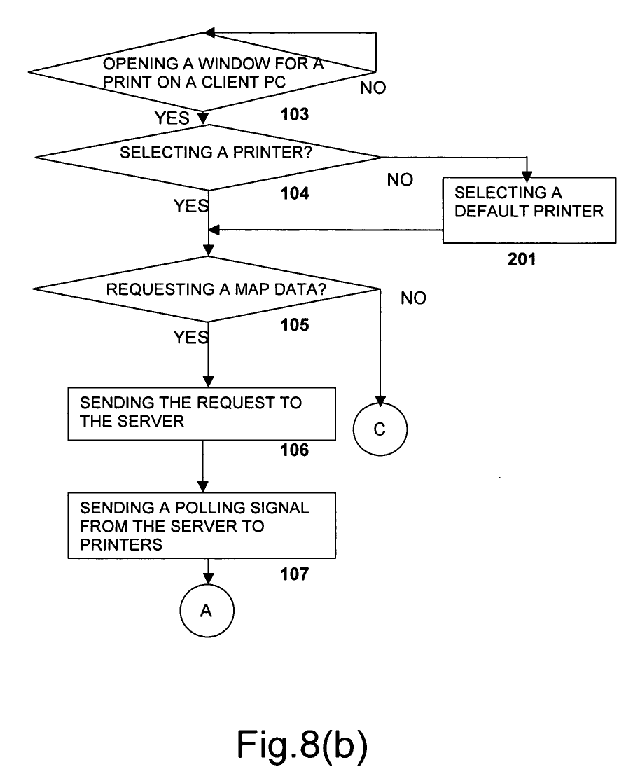

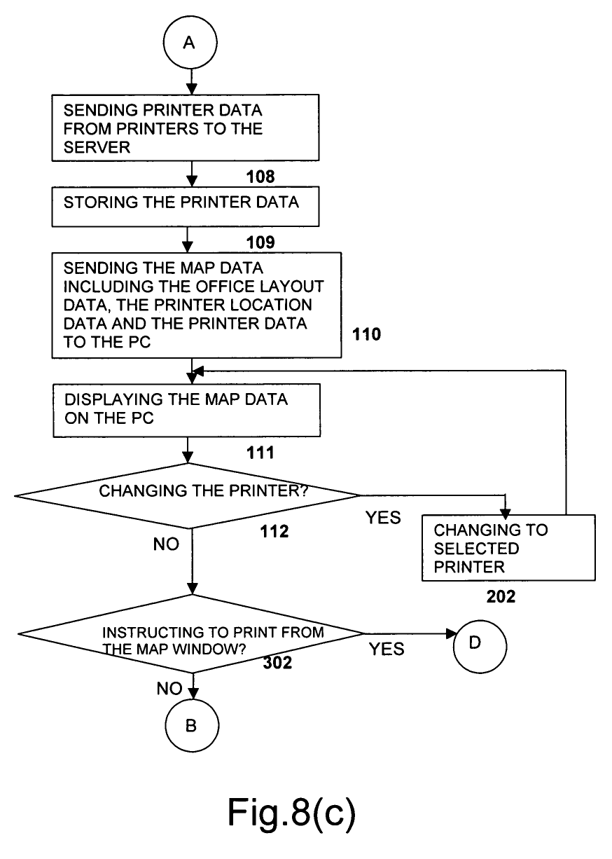

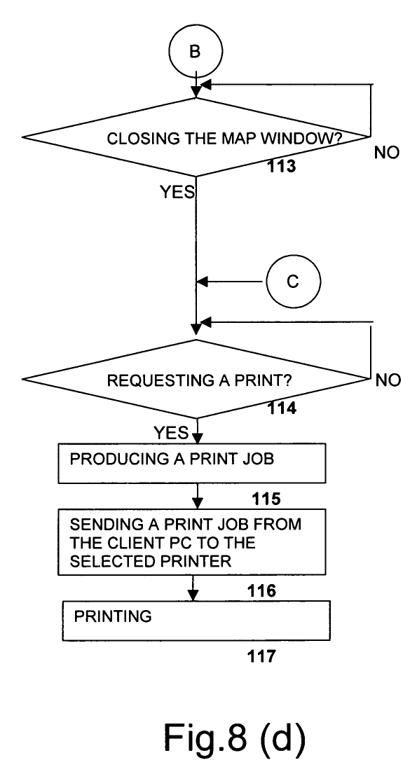

By clicking the icon 24 for changing the printer with the mouse 17 or the keyboard 15 of the PC 1, the user can select the printer (104 in FIG. 8(a)). If the icon 24 is not clicked, the default printer can be designated as a selected printer (201 in FIG. 8(a)). In this example, the default printer is Konica Minolta bwx-7050 (BAN LBP 5).

In this example, by clicking the icon 21 for requesting to display the map data with the mouse 17 or the keyboard 15, the user can request to display the map data instead of clicking the icon displayed on the main screen (105 in FIG. 8(a)). If the icon 21 is clicked from the PC 1, a request signal for displaying the map data can be produced by the CPU 11 and be transmitted from the LAN adaptor 16 to the server 4 through the LAN 9 according to the printer driver software. (106 in FIG. 8(a))

With regard to the instruction of printing, it is described as follows.

If the user does not instruct to start printing from the map window, after closing the map window, the print window 20 can be still remained on the color LCD display 14. If the user changes the printer on the map window, that change can be reflected on the selected printer in the print window 20 also.

Then, the user can instruct start of printing from the keyboard 15 or the mouse 17 of the PC 1 by clicking the icon 22 for starting the print in the print window 20 displayed on the color LCD display 14. Then, the CPU 11 of the PC 1 can produce the print job based on the document data and the PC 1 can transmit the print job to the designated printer (in this example, B/W LBP 5) from the LAN adaptor 16 through the server 4. The BAN LBP 5 can receive the print job through the server and print based on the print job sent from the PC 1.

Other various embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A printing system comprising:
a printer,
a host computer, comprising;
a map data storing unit which stores a map data comprising an office layout data showing a layout of an office graphically and a printer location data showing a location of the printer graphically in the layout of the office,
a transmit unit which transmits the map data,
a client computer, comprising;
a display unit,
an input unit by which an user selects at least one of the printers for printing,
wherein the printer, the host computer and the client computer are connected via a network, and
wherein the display unit displays the layout of the office and the location of the printer selected by the input section graphically based on the map data stored in the map data storing section and transmitted by the transmit unit from the host computer to the client computer.

2. The printing system of claim 1, wherein the printing system further comprises a management computer comprising an input unit by which the map data is input and a transmit unit to transmit the map data input in the management computer to the host computer, and,
wherein map data storing unit of the host computer stores the map data transmitted from the management computer by the transmit unit of the management computer.

3. The printing system of claim 1, wherein the display unit displays the map data so that the printer selected by the input section of the client computer is emphasized in the map data.

4. The printing system of claim 1, wherein the map data further comprises printer data including at least one of a name of the printer, a category of the printer, a condition of the printer, a specification of the printer.

5. The printing system of claim 1, wherein the display unit displays printer icons to show the location of printers based on the map data, and
wherein the printer is selected by clicking the printer icon from the input unit.

6. A printing system comprising:
a printer,
a host computer, comprising;
means for storing a map data comprising an office layout data showing a layout of an office graphically and a printer location data showing a location of the printer graphically in the layout of the office,
means for transmitting the map data,
a client computer, comprising;
means for displaying,
means for inputting a selection of the printer for printing by the user,
wherein the printer, the host computer and the client computer are connected via a network, and
wherein the displaying means displays the layout of the office and the location of the printer selected by the inputting means graphically based on the map data stored in the map data storing means and transmitted by the transmitting means from the host computer to the client computer.

7. A removable data recording medium that stores instructions, which when executed by a host computer perform steps in a method for representing configuration options available on devices in a printing system comprising the host computer, a client computer and a printer, the steps comprising:
receiving a map data comprising an office layout data showing a layout of an office graphically, and a printer location data showing a location of the printer graphically in the layout of the office,
storing the map data,
receiving a request signal of the map data comprising a data of a selected printer from the client computer,
transmitting the map data showing the location of the selected printer in the layout of the office to the client computer transmitting the request signal.

8. A host computer included in a printing system comprising a printer, a client computer, the host computer comprising;
a map data storing unit which stores a map data comprising an office layout data showing a layout of an office graphically and a printer location data showing a location of the printer graphically in the layout of the office,
a transmit unit which transmits the map data to the client computer replying to a request signal transmitted from the client computer.
